(19) United States
(12) Patent Application Publication
(10) Pub. No.: US 2019/0232302 A1
(43) Pub. Date: Aug. 1, 2019

(54) A Hydrocyclone

(71) Applicant: Vulco S. A., Santlago (CL)

(72) Inventors: Mark Lockyer, Woodlands (AU); Debra Switzer, Cody, WY (US); Eduardo Cepeda, Santiago (CL); Javier Lopez, Santiago (CL)

(21) Appl. No.: 16/329,857

(22) PCT Filed: Sep. 2, 2017
(86) PCT No.: PCT/AU2017/050949

§ 371 Date: Mar. 1, 2019

(30) Foreign Application Priority Data
Sep. 2, 2016 (AU) 2016903532

(51) Int. Cl. B04C 5/04; B04C 5/08; B04C 5/12

(52) U.S. Cl. CPC B04C 5/04; B04C 5/12; B04C 5/08

(57) ABSTRACT

A hydrocyclone (10) is disclosed in which the inlet section (14) of the chamber (13) has a curved inner side wall surface (29) which is generally in the shape of a volute (28), for directing material received in use from the feed inlet port (17) in a rotational motion. In the embodiment shown, the volute (28) is ramped axially downward within the inlet section (14), in a direction towards the conical separating section (15), and turns through an angle of more than 270 angle degrees. The conical section has a central axis X-X, and comprises two segments 32, 34 each being of a frustoconical shape, and joined together end to end to form a generally conical separating chamber (15). An internal angle A located between an inner wall surface (50) of the so-formed conical separating chamber (15) and a line parallel to the central axis X-X is ideally less than (8) angle degrees, to provide a hydrocyclone design with beneficial operating parameters.

### TECHNICAL FIELD

This disclosure relates generally to hydrocyclones and more particularly, but not exclusively, to hydrocyclones suitable for use in the mineral and chemical processing industries. The disclosure is also concerned with the design of hydrocyclones as a means of optimising their performance.

### BACKGROUND OF THE DISCLOSURE

Hydrocyclones are used for separating suspended matter carried in a flowing liquid such as a mineral slurry into two discharge streams by creating centrifugal forces within the hydrocyclone as the liquid passes through a conical shaped chamber. Basically, hydrocyclones include a conical separating chamber, a feed inlet which is usually generally tangential to the axis of the separating chamber and is disposed at the end of the chamber of greatest cross-sectional dimension, an underflow outlet at the smaller end of the chamber, and an overflow outlet at the larger end of the chamber.

The feed inlet is adapted to deliver the liquid containing suspended matter into the hydrocyclone separating chamber, and the arrangement is such that the heavy (for example, denser and coarser) matter tends to migrate towards the outer wall of the chamber and towards and out through the centrally located underflow outlet. The lighter (less dense or finer particle sized) material migrates towards the central axis of the chamber and out through the overflow outlet. Hydrocyclones can be used for separation by size of the suspended solid particles or by particle density. Typical examples include solids classification duties in mining and industrial applications.

For enabling efficient operation of hydrocyclones the internal geometric configuration of the larger end of the chamber where the feed material enters, and of the conical separating chamber are important. In normal operation such hydrocyclones develop a central air column, which is typical of most industrially-applied hydrocyclone designs. The air column is established as soon as the fluid at the hydrocyclone axis reaches a pressure below the atmospheric pressure. This air column extends from the underflow outlet to the overflow outlet and simply connects the air immediately below the hydrocyclone with the air at the top. The stability and cross sectional area of the air core is an important factor in influencing the underflow and overflow discharge condition, to maintain normal hydrocyclone operation.

During normal “stable” operation, the slurry enters through an upper inlet of a hydrocyclone separation chamber in the form of the inverted conical chamber to become separated cleanly. However, the stability of a hydrocyclone during such an operation can be readily disrupted, for example by collapse of the air core due to overfeeding of the hydrocyclone, resulting in an ineffective separation process, whereby either an excess of fine particulates exit through the lower outlet or coarser particulates exit through the upper outlet.

Another form of unstable operation is known as “roping”, whereby the rate of solids being discharged through the lower outlet increases to a point where the flow is impaired. If corrective measures are not timely adopted, the accumulation of solids through the outlet will build up in the separation chamber, the internal air core will collapse and the lower outlet will discharge a rope-shaped flow of coarse solids.

Unstable operating conditions can have serious impacts on downstream processes, often requiring additional treatment (which, as will be appreciated, can greatly impact on profits) and also result in accelerated equipment wear. Hydrocyclone design optimisation is desirable for a hydrocyclone to be able to cope with changes to the composition and viscosity of input slurry, changes in the flowrate of fluid entering the hydrocyclone, and other operational instabilities.

### SUMMARY

Embodiments are disclosed of a hydrocyclone including:
a feed chamber, the feed chamber having an inner side wall, a top wall located at an in use upper end of the inner side wall, an open end located at an in use lower end of the inner side wall, and being opposite said top wall, the open end being of circular cross-section and having a central axis X-X, an overflow outlet located at the top wall, and an inlet port for delivering material to be separated to the feed chamber;
a feed inlet zone located at the inner side wall of the feed chamber, the feed inlet zone being defined generally in the shape of a volute, wherein the distance from the inner side wall to the central axis X-X decreases with the progression of the volute around the inner side wall in a direction away from the inlet port; and the volute subtends an angle of greater than 270 angle degrees;
a generally conical separating chamber which extends from a first end at a region of relatively large cross-sectional area located adjacent the open end of the feed chamber, to a second end of relatively smaller cross sectional area;
a spigot which extends from the second end of the conical separating chamber, which in use provides an outlet for material exiting the hydrocyclone; and
   wherein the internal angle between an inner wall of the conical separating chamber and a line parallel to the central axis X-X is less than 8 angle degrees.

This physical configuration has been found to promote a stable cyclone discharge flow, minimise any back pressure on the cyclone system process, maximise the cross-sectional area of the central axial air core generated within the cyclone, maximise throughput of product in terms of, for example, tonnage per hour, and maintain the physical separation process parameters at a stable level.

The inventors surmise that fluid flow generated by using the combination of a volute-shaped inner side wall of the feed chamber, extending at least three-quarters around the circumference thereof, and flowing into a gently-tapered conical separating chamber, can enable these operational advantages.

In certain embodiments, the volute subtends an angle of about 360 angle degrees.

In certain embodiments, the internal angle between the inner wall of the conical separating chamber and the line parallel to the central axis X-X is between 4 to 6 angle degrees. In one preferred embodiment, the said angle is about 5 angle degrees.

In certain embodiments, the generally conical separating chamber comprises two segments each being of a frustoconical shape, and joined together end to end.

In certain embodiments, the hydrocyclone includes an overflow outlet control chamber located at the top wall of the feed chamber and in fluid communication therewith via the overflow outlet.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments which will be described:

FIG. 1 is a sectional schematic view (in plane A-A) of a hydrocyclone in accordance with a first embodiment of the present disclosure;

FIG. 2 is a schematic perspective view of the hydrocyclone in accordance with FIG. 1;

FIG. 3a is a perspective schematic view of a lower portion of the feed chamber of the hydrocyclone according to FIG. 1;

FIG. 3b is an underside plan view of the lower portion of the feed chamber of FIG. 3a;

FIG. 3c is a top plan view of the lower portion of the feed chamber of FIG. 3a when viewed along plane Y-Y which is orthogonal to central axis X-X;

FIG. 4 is a further perspective schematic view of a lower portion of the feed chamber part of the hydrocyclone according to FIG. 1; and

FIG. 5 is a partial perspective schematic view of a lower portion of the feed chamber part of the hydrocyclone according to FIG. 1.

### DETAILED DESCRIPTION

This disclosure relates to the design features of a hydrocyclone of the type that facilitates separation of a liquid or semi-liquid material mixture into two phases of interest. The hydrocyclone has a design which enables a stable operation, with maximised throughput and good physical separation process parameters.

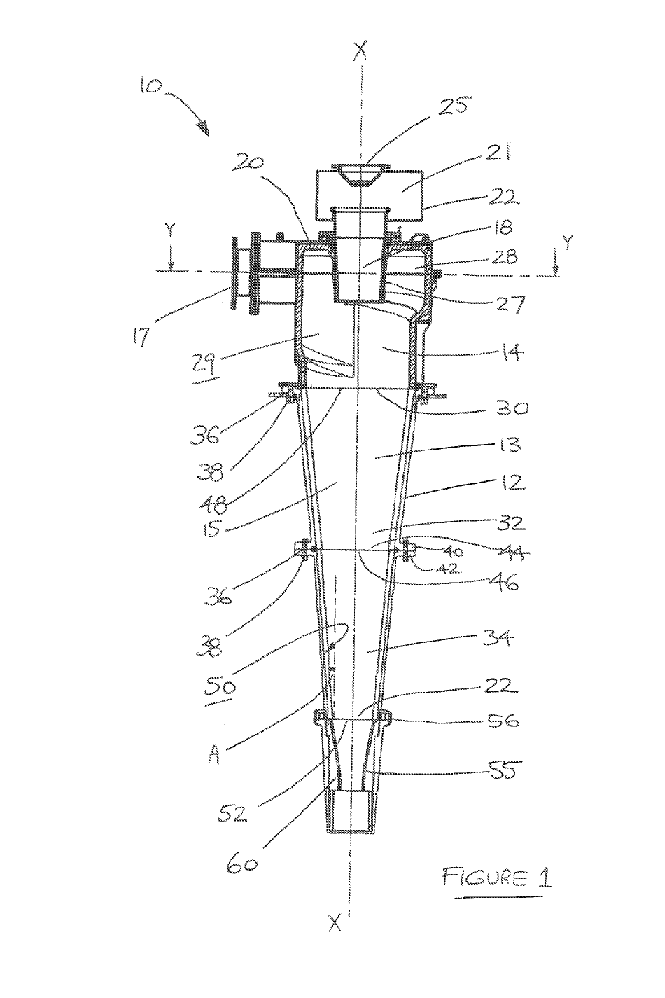

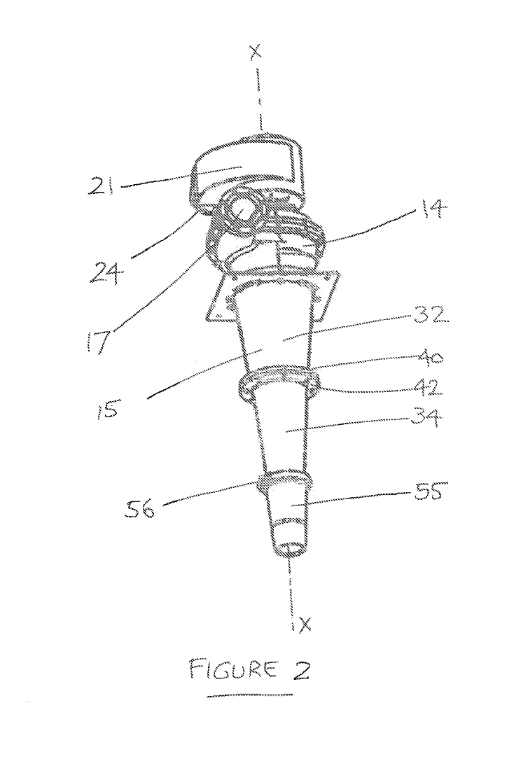

A hydrocyclone, when in use, is normally orientated with its central axis X-X being disposed upright, or close to being upright. With reference to FIG. 1, there is shown a sectional schematic of a hydrocyclone 10 comprising a main body 12 having a chamber 13 defined therein. The chamber 13 comprises an inlet (or feed) section 14 and a conical separating section 15. The hydrocyclone further includes a cylindrical feed inlet port 17 of circular cross-section, in use for feeding a particle-bearing mixture in the form of a particulate slurry into the inlet section 14 of the chamber 13.

An overflow outlet (hereafter “upper outlet”) 18 is centrally located in the flat, disc-like upper (top) wall 20 of the chamber 13, the overflow outlet 18 used for discharge of a first one of the phases. Typically, this overflow outlet 18 is in the form of a cylindrical, short length of pipe and is known as a vortex finder 27, which both projects outwardly from the upper wall 20, and also extends from the upper wall 20 into so the interior of the chamber 13.

An underflow outlet (hereafter “lower outlet”) 22 is centrally located at the other end of the chamber 13 (that is, at the apex of the conical separating section 15) being remote from the inlet section 14, in use for discharge of a second one of the phases. The underflow outlet 22 shown in the drawings is the open end of the conical separating section 15. In the hydrocyclone 10 in use, material passing via the underflow outlet 22 flows into a further section in the form of a cylindrical length of pipe known as a spigot 55, itself having an inlet 52 opening of similar diameter and mating cross-section with the underflow outlet 22. The spigot 55 has an inwardly tapered internal surface lining 60 of a different tapered shape to that of the inner wall surface 50 of the conical separating section 15, as will be described.

The hydrocyclone 10 is arranged in use to generate an internal air core around which the slurry circulates. During stable operation, the hydrocyclone 10 operates such that a lighter solid phase of the slurry is discharged through the uppermost overflow outlet 18 and a heavier solid phase is discharged through the lower underflow outlet 22, and then via the spigot 55. The internally-generated air core runs the length of the main body 12.

The hydrocyclone 10 optionally further includes an overflow outlet control chamber 21 which is located adjacent the inlet section 14 of the chamber 13 of the hydrocyclone 10, and is in fluid communication therewith via the vortex finder 27. The overflow outlet control chamber 21 includes a tangentially-located discharge outlet 24 and a centrally located air core stabilising orifice 25 which is remote from the overflow outlet 18. The stabilising orifice 25, vortex finder 27 and overflow outlet 18 are generally axially aligned along the central axis X-X of the hydrocyclone 10.

The overflow outlet control chamber 21 has a curved inner side wall surface (not shown) which is generally in the shape of a volute, for directing material received in use from the chamber 13 towards the discharge outlet 24. This volute shape may extend around the inner surface of the outlet control chamber 21 for up to 360 angle degrees.

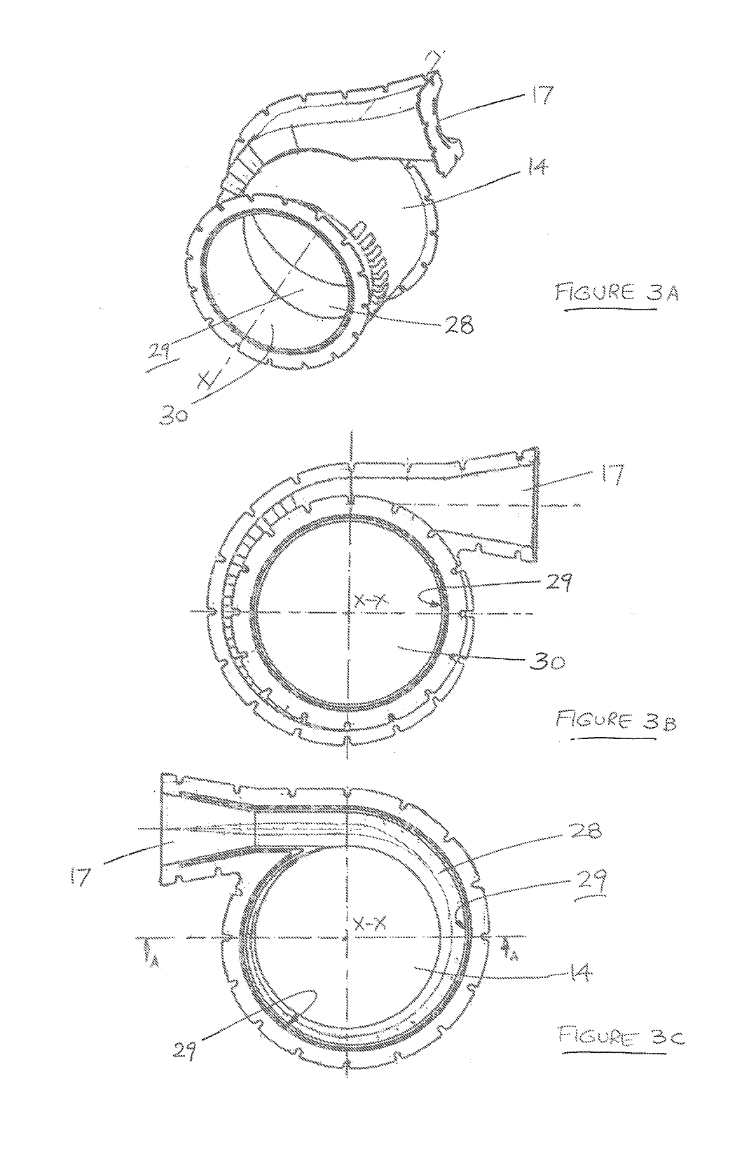

The inlet section 14 of the chamber 13 of the hydrocyclone 10 has a curved inner side wall surface 29 which is generally in the shape of a volute 28, for directing material received in use from the feed inlet port 17 in a rotational motion within the inlet section 14 (a so-called feed inlet zone). Feed material that is received via the feed inlet port 17 is generally flowing tangential to the inner side wall surface 29. In the embodiment shown, the volute 28 is ramped axially downward within the inlet section 14, in a direction towards the conical separating section 15, and turns through an angle of 360 angle degrees. As shown in FIG. 3C and FIG. 5, the distance from the volute-shaped inner side wall surface 29 to the central axis X-X of the inlet section 14 of the hydrocyclone chamber 13 decreases with the progression of the volute around the inner side wall surface 29 when moving in a direction away from the feed inlet port 17.

In some other embodiments, a similar style of volute-shaped inner side wall can be ramped axially downwardly about the inner surface of the inlet section 14 subtending other angles, ranging from more than 270 angle degrees to less than 360 angle degrees, each one being arranged in use to move the solid-liquid feed material into a rotational motion within the inlet section 14.

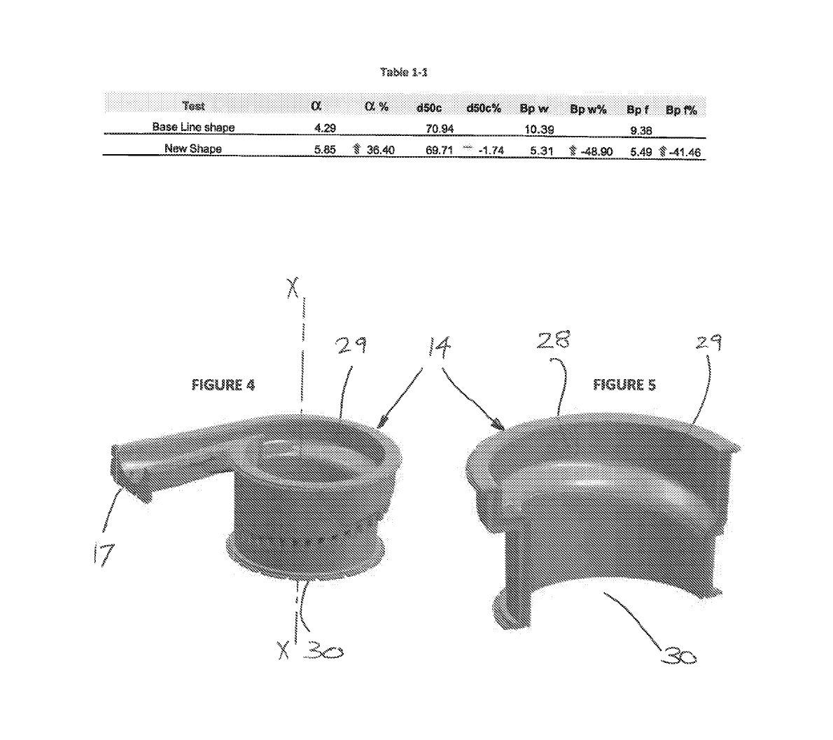

As shown in FIGS. 3A, 3B, 4 and 5, the inlet section 14 of the chamber 13 of the hydrocyclone 10 has a lowermost open-end region 30, located at the end of the volute-shaped inner side wall surface 29, and which is circular in cross-section. This open-end region 30 is located at an opposite end of the inlet section 14 to the upper wall 20 thereof. In use, material flows from the volute 28 within the inlet section 14, out via the open end region 30 of the inlet section 14, and immediately into the conical separating section 15 of the hydrocyclone 10. The circular, lowermost open-end region 30 also has a central axis X-X, and is generally axially aligned with the aforementioned vortex finder 27 and overflow outlet 18 along the central axis X-X of the hydrocyclone 10.

The conical separating chamber 15 of the hydrocyclone 10 comprises two segments 32, 34 each being of a frustoconical shape, and joined together end to end by nuts 36 and bolts 38 located at mating circumferential flanges 40, 42 arranged at a respective end of the two frustoconical segments 32, 34. The two frustoconical segments 32, 34 are of similar shape but one 32 is larger than the other 34, such that the narrowest end internal diameter 44 of the largest segment 32 is similar to the largest end internal diameter 46 of the smaller segment 34. Also, the largest end internal diameter 48 of the largest segment 32 is similar to the diameter of the lowermost open-end region 30 of the inlet section 14.

Joining of the two frustoconical segments 32, 34 end-to end forms a generally conical separating chamber 15 having a central axis X-X, and which is joined in use adjacent the open end 30 of the adjacent feed chamber 14, to form the main body of the hydrocyclone 10. When the frustoconical segments 32, 34 are joined together, the internal angle A located between an inner wall surface 50 of the so-formed conical separating chamber 15 and a line parallel to the central axis X-X is about 5 angle degrees, in one preferred form as shown in FIG. 1. It has also been found that an angle A of between 4 and 6 angle degrees also provides a hydrocyclone design having beneficial operating parameters.

In still other embodiments within the scope of the present disclosure, the internal angle A between the inner wall surface 50 of the conical separating chamber 15 and the line parallel to the central axis X-X can be an angle of less than 8 angle degrees, to still result in a hydrocyclone design having beneficial operating parameters.

The final section of the hydrocyclone 10 is an end segment known as a spigot 55, which is circular in cross-section and which has an inlet opening 52 which is joined in use to the circular, open-end underflow outlet 22 of the smaller frustoconical segment 34 of the separating chamber 15. The spigot 55 also has a central axis X-X and is generally axially aligned with the aforementioned separating chamber 15 of the hydrocyclone 10. The spigot 55 is joined end-to-end to the frustoconical segment 34 by way of a coupling 56 located at mating circumferential flanges, one flange arranged at an upper end of spigot 55, and the other flange being adjacent to the lowermost open-end region 22 of the frustoconical segment 34. Because the spigot 55 provides an outlet for material exiting the hydrocyclone, it can be subject to significant erosive wear, and is usually more heavily-lined with wear-resistant material, for example a ceramic liner 60 having a different shape compared with the segments of the conical separating chamber 15.

### Experimental Results

Experimental results have been produced by the inventors using the new equipment configuration disclosed herein, to assess the metallurgically beneficial outcomes from the operation of the new hydrocyclone, in comparison with the baseline case (without the new configuration).

Table 1-1 shows the results of various experiments in which results from a hydrocyclone of the new configuration, compared to a conventional hydrocyclone.

The parameters which were calculated included: the percentage (%) change in the amount of water bypass (WBp); and the percentage (%) change in the amount of fine particles (Bpf) which bypass the classification step. In a poorly-operating hydrocyclone, some water and fine particles are improperly carried away in the cyclone coarse particle underflow (oversize) discharge stream, rather than reporting to the fine particle overflow stream, as should be the case during optimal cyclone operation. The parameters WBp and Bpf provide a measure of this.

Also observed was the percentage (%) change in the average particle cut size (d50) in the overflow stream from the classification step, as a measure of whether more or less fine particles reported to the fine particle overflow stream. Particles of this particular size d50, when fed to the equipment, have the same probability of reporting to either the underflow or to the overflow.

Also observed was a quantification of the efficiency factor of classification of the hydrocyclone, in comparison with a calculated ‘ideal classification’. This parameter alpha (a) represents the acuity of the classification. It is a calculated value, which was originally developed by Lynch and Rao (University of Queensland, JK Minerals Research Centre, JKSimMet Manual). The size distribution of particulates in a feed flow stream is quantified in various size bands, and the percentage in each band which reports to the underflow (oversize) discharge stream is measured. A graph is then drawn of the percentage in each band which reports to underflow (as ordinate, or Y-axis) versus the particle size range from the smallest to the largest (as abscissa, or X-axis). The smallest particles have the lowest percentage reporting to oversize. At the d50 point of the Y-axis, the slope of the resultant curve gives the alpha (α) parameter. It is a comparative number which can be used to compare classifiers. The higher the value of the alpha parameter, the better the separation efficiency will be.

When comparing the use of the overflow outlet control device having an internal chamber in accordance with the present disclosure with a hydrocyclone which does not have any overflow outlet control chamber, the data in Table 1-1 demonstrates:
a 48.9% reduction in the amount of water bypassing (WBp) the hydrocyclone classification by ending up in the underflow stream;
a 41.5% reduction in the amount of fine particles (Bpf) which bypassed the classification step by ending up in the underflow stream;
a slight (1.7%) reduction the average particle cut size (d50) in the overflow stream from the classification step; and
a 36.4% improvement in the a separation efficiency parameter.

In summary, there were major improvements to the water bypass (WBp), and to the amount of fine particles (Bpf) bypassing the classification step by ending up in the underflow stream using a hydrocyclone of the present disclosure—in addition there was a major improvement in the α separation efficiency parameter. All of these measured improvements were surprisingly large and unexpected.

In some further test work performed at a minerals processing plant, the customer wanted a reduction in the particle cut size P80 (the size which 80% of the material is smaller than). In other words, they wanted to produce a finer particle size distribution slurry, which was then expected to give better downstream separation performance. To develop hydrocyclone equipment able to achieve this cut size involved changing the angle of the cone interior from the initial design of a fully subtended angle at cyclone base of 18° (which is equivalent to 9° angle subtended from the inner cone wall to the central axis X-X) to use a fully subtended angle at cyclone base of 13° (which is equivalent to 6.5° angle subtended from the inner cone wall to the central axis X-X), which was now within the claimed range of less than 8 angle degrees.

The data which was measured from the field trial is about the particle size distribution or “cut” which was able to be achieved by equipment of this new configuration.

CONE ANGLE SUBTENDED
FROM VERTICAL

| MESH | MICRONS | 6.5 | 9 |
|---|---|---|---|
| 8 | 2378 | 100.00 | 100.00 |
| 12 | 1681 | 100.00 | 100.00 |
| 16 | 1189 | 100.00 | 100.00 |
| 20 | 840 | 99.99 | 99.98 |
| 30 | 594 | 99.85 | 99.76 |
| 40 | 420 | 99.01 | 98.59 |
| 50 | 296 | 96.15 | 95.03 |
| 70 | 210 | 90.07 | 88.12 |
| 100 | 148 | 80.37 | 77.72 |
| 140 | 105 | 68.49 | 65.53 |
| 200 | 74 | 55.69 | 52.80 |
| 270 | 52 | 43.56 | 40.99 |
| 400 | 37 | 33.44 | 31.29 |
| P80 | | 164.00 | 185.00 |

In fact, the hydrocyclone of the new configuration was able to give a remarkable reduction in particle cut size by reducing the P80 from 185 micrometres to 164 micrometres. Only a small reduction in the conical angle from 9° to 6.5°, in combination with the other features of the hydrocyclone, gave a result which meant that the finer ore material was able to be sent for more efficient downstream processing (such as mineral flotation), and the oversize materials was able to be sent back for regrinding to liberate further value minerals and thus to improve the overall processing plant yield.

The inventors have discovered that the use of the above embodiments of a hydrocyclone separation apparatus can realise optimum operating conditions which do not depend on the hydrodynamics of the slurry, and this physical configuration has been found to:
promote a stable cyclone discharge flow,
minimise any back pressure on the cyclone system process,
maximise the cross-sectional area of the central axial air core generated within the cyclone,
maximise throughput of product in terms of, for example, tonnage per hour, and
maintain the physical separation process parameters at a stable level.

The inventors surmise that fluid flow generated by using the combination of a volute-shaped inner side wall of the feed chamber, extending for at least three-quarters and up to one circumference therearound, and immediately followed by a fluid flowing into a relatively gently-tapering conical separating chamber, enables these operational advantages by offering a fluid path which minimises turbulence in the flow.

The main effect on the overall minerals processing plant is related to the increased recovery in the subsequent flotation circuit, and the decrease in the recirculating load, thus allowing for an increased capacity to handle fresh feed. The inventors believe that the increase in capacity may be more than 20%, as a result of this change to hydrocyclone geometry.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and “lower”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive. For example, the conical section of the hydrocyclone may be made up of more than two frustoconical segments, joined end-to-end. The means by which such frustoconical segments are joined to one another may not merely be via bolts and nuts positioned at the edges of terminal flanges, but by other types of fastening means, such as some type of external clamp. The materials of construction of the hydrocyclone body parts, whilst typically made of hard plastic or o metal, can also be of other materials such as ceramics. The interior lining material of the hydrocyclone parts can be rubber or other elastomer, or ceramics, formed into the required internal shape geometry of the feed chamber 14 or the conical separating chamber 15, as specified herein.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realise yet other embodiments. Further, each independent feature or component of any given assembly may constitute an additional embodiment.

1. A hydrocyclone including:
a feed chamber, the feed chamber having:
an inner side wall,
a top wall located at an in use upper end of the inner side wall,
an open end located at an in use lower end of the inner side wall, and being opposite said top wall, the open end being of circular cross-section and having a central axis X-X,
an overflow outlet located at the top wall, and
an inlet port for delivering material to be separated to the feed chamber;
a feed inlet zone located at the inner side wall of the feed chamber, the feed inlet zone being defined generally in the shape of a volute, wherein:
the distance from the inner side wall to the central axis X-X decreases with the progression of the volute around the inner side wall in a direction away from the inlet port; and
the volute subtends an angle of greater than 270 angle degrees;
a generally conical separating chamber which extends from a first end at a region of relatively large cross-sectional area located adjacent the open end of the feed chamber, to a second end of relatively smaller cross sectional area;
a spigot which extends from the second end of the conical separating chamber, which in use provides an outlet for material exiting the hydrocyclone; and
wherein the internal angle between an inner wall of the conical separating chamber and a line parallel to the central axis X-X is less than 8 angle degrees.

2. The hydrocyclone according to claim 1, wherein the volute subtends an angle of about 360 angle degrees.

3. The hydrocyclone according to claim 1, wherein the internal angle between the inner wall of the conical separating chamber and the line parallel to the central axis X-X is between 4 to 6 angle degrees.

4. The hydrocyclone according to claim 1, wherein the internal angle between the inner wall of the conical separating chamber and the line parallel to the central axis X-X is about 5 angle degrees.

5. The hydrocyclone according to claim 1, wherein the generally conical separating chamber comprises two segments each being of a frustoconical shape, and joined together end to end.

6. The hydrocyclone according to claim 1, including an overflow outlet control chamber located at the top wall of the feed chamber and in fluid communication therewith via the overflow outlet.

7. The hydrocyclone according to claim 2, including an overflow outlet control chamber located at the top wall of the feed chamber and in fluid communication therewith via the overflow outlet.

8. The hydrocyclone according to claim 3, including an overflow outlet control chamber located at the top wall of the feed chamber and in fluid communication therewith via the overflow outlet.

9. The hydrocyclone according to claim 4, including an overflow outlet control chamber located at the top wall of the feed chamber and in fluid communication therewith via the overflow outlet.

10. The hydrocyclone according to claim 5, including an overflow outlet control chamber located at the top wall of the feed chamber and in fluid communication therewith via the overflow outlet.

11. The hydrocyclone according to claim 2, wherein the generally conical separating chamber comprises two segments each being of a frustoconical shape, and joined together end to end.

12. The hydrocyclone according to claim 3, wherein the generally conical separating chamber comprises two segments each being of a frustoconical shape, and joined together end to end.

13. The hydrocyclone according to claim 4, wherein the generally conical separating chamber comprises two segments each being of a frustoconical shape, and joined together end to end.
